(19) United States
(12) Patent Application Publication
(10) Pub. No.: US 2020/0334740 A1
(43) Pub. Date: Oct. 22, 2020

(54) SYSTEM AND METHOD FOR A HYBRID CONVERSATIONAL AND GRAPHICAL USER INTERFACE

(71) Applicant: DYNAMICLY INC., Montreal (CA)

(72) Inventors: Barry Joseph BEDELL, Montreal (CA); Cédric LEVASSEUR-LABERGE, Montreal (CA); Justine GAGNEPAIN, Montreal (CA); Eliott MAHOU, Montreal (CA)

(21) Appl. No.: 16/753,517

(22) PCT Filed: Oct. 5, 2018
(86) PCT No.: PCT/CA2018/051264

§ 371 Date: Apr. 3, 2020

Related U.S. Application Data
(60) Provisional application No. 62/569,015, filed on Oct. 6, 2017.

(51) Int. Cl. G06Q 30/06; G06F 16/9032; G06F 40/35

(52) U.S. Cl. CPC G06Q 30/0641; G06F 16/90332; G06F 16/9535; G06Q 30/0631; G06F 40/35

(57) ABSTRACT

A computer-implemented method is provided and allows a user to interact with a website or web application. The method includes steps of capturing inputs of the user in a Conversational User Interface (CUI) and/or in a Graphical User Interface (GUI) of the website or web application and of modifying the CUI based on GUI inputs and/or GUI based on CUI inputs. An intent of the user can be determined based on the captured CUI or GUI inputs. A context can also be determined based on CUI interaction history and GUI interaction history. The CUI or GUI can be modified to reflect a match between the intent and the context determined. A computer system and a non-transitory readable medium are also provided.

### RELATED APPLICATIONS

The present application is a national stage application under 35 U.S.C. § 371 of International Application No. PCT/CA2018/051264, filed 5 Oct. 2018, which claims priority to U.S. Provisional Patent Application No. 62/569,015, filed 6 Oct. 2017. The above referenced applications are hereby incorporated by reference into the present application in their entirety.

### TECHNICAL FIELD

The present invention generally relates to the field of conversational user interfaces, including chatbots, voicebots, and virtual assistants, and more particularly, to a system that seamlessly and bi-directionally interacts with the visual interface of a website or web application.

### BACKGROUND

Websites and web applications have become ubiquitous. Almost every modern business has a web presence to promote their goods and services, provide online commerce (“e-commerce”) services, or provide online software services (e.g. cloud applications). Modern day websites and applications have become very sophisticated through the explosion of powerful programming languages, frameworks, and libraries. These tools, coupled with significant developer expertise, allow for fine-tuning of the user experience (UX).

Recently, an increasing number of websites and web applications are incorporating “chat” functionality. These chat interfaces allow the user to interact either with a live agent or with an automated system, also known as a “chatbot”. Such interfaces can be utilized for a variety of purposes to further improve the user experience, but most commonly focus on customer service and/or providing general information or responses to frequently asked questions (FAQs). While chat interfaces have traditionally been text-based, the advent of devices, such as the Amazon Echo and Google Home, have introduced voice-only chatbots, or “voicebots”, that do not rely on a visual interface. Collectively, these text and voice bots can be referred to as “conversational user interfaces” (CUIs).

Several of the large technology companies (Amazon, Facebook, Google, IBM, Microsoft) have recently launched powerful cognitive computing/AI platforms that allow developers to build CUIs. Furthermore, a number of smaller technology companies have released platforms for “self-service” or “do-it-yourself (DIY)” chatbots, which allow users without any programming expertise to build and deploy chatbots. Finally, several of the widely used messaging platforms (e.g. Facebook Messenger, Kik, Telegram, WeChat) actively support chatbots. As such, CUIs are rapidly being deployed across multiple channels (web, messaging apps, smart devices). It is anticipated that, over the next few years, businesses will rapidly adopt CUIs for a wide range of uses, including, but not limited to, digital marketing, customer service, e-commerce, and enterprise productivity.

That said, CUIs are still not well-integrated into websites. An online shopping site can be used as an illustrative example. Typically, the user will use various GUI tools (search field, drop-down menu, buttons, checkboxes) to identify items of interest. Once a particular item has been identified, the user can select that item (e.g. mouse click on computer; tap on mobile device) to get more information or to purchase it. This well-established process has been developed based on the specific capabilities of personal computers and mobile devices for user interactions, but can be cumbersome and time-consuming.

As such, there is a need for improved conversational and graphical user interfaces.

### SUMMARY

According to an aspect, a computer-implemented method is provided, for modifying a Conversational User Interface (CUI) and Graphical User Interface (GUI) associated with a website or a web application, running on a front-end device. For example, the website can be an e-commerce website. The CUI can, for example, be a native part of the website or web application, or alternately, it can be a browser plugin. Optionally, the CUI can be activated using a hotword.

The method comprises a step of capturing user interactions with the website or web application on the front-end device. The user interactions can include GUI inputs, CUI inputs, or both. CUI inputs can include, for example, text inputs and/or and speech inputs. The GUI inputs can include mouse clicking; scrolling; swiping; hovering; and tapping through the GUI. Optionally, when the captured inputs are speech audio signals, the audio signals can be converted into text strings with the use of a Speech-to-Text engine.

The method also includes a step of determining user intent, based on captured GUI and/or CUI inputs. The method also includes a step of building a context chain, based on GUI interaction history and/or CUI interaction history of the user on the website or a web application. The method also comprises finding a match between said intent and context chain and retrieving a list of actions based on said match. The list of actions is executed at the back-end system and/or at the front-end device. Executing the actions can modify the CUI, based on the captured GUI inputs; and/or modify the GUI, based on the captured CUI inputs. For example, the information displayed on the GUI can be altered or modified, based on a request made by the user through the CUI; and/or a question can be asked to the user, by displaying text or emitting speech audio signals, through the CUI, based on a selection by the user of a visual element displayed on the GUI.

According to a possible implementation of the method, a session between the front-end device and a back-end system is established, prior to or after capturing the user interactions. In order to establish a communication between the front-end device and the back-end system, a WebSocket connection or an Application Program Interface (API) using the HyperText Transfer Protocol (HTTP) can be used. Still optionally, determining user intent can be performed by passing the CUI inputs through a Natural Language Understanding (NLU) module of the back-end system, and passing the GUI inputs through a Front-End Understanding (FEU) module of the back-end system module. Determining the user intent can be achieved by selecting the intent from a list of predefined intents. User intent can also be determined by using an Artificial Intelligence module and/or a Cognitive Computing module. Additional modules can also be used, including, for example, a Sentiment Analysis module, an Emotional Analysis module, and/or a Customer Relationship Management (CRM) module, to better define user intent and/or provide additional context information data to build the context chain.

Preferably, query parameters, which can be obtained via the CUI and/or GUI inputs, are associated with the user intent. These parameters may be passed to actions for execution thereof. As for the context chain, it can be built by maintaining a plurality of contexts chained together, based on navigation history on the GUI; conversation history of the user with the CUI; user identification, front-end device location, date and time, as examples only. The steps of finding a match between the user intent and the context chain can be achieved in different ways, such as by a referring to a mapping table stored in a data store of a back-end system; using a probabilistic algorithm; or using conditional expressions embedded in the source code. The step of retrieving the list of actions for execution can also be performed using similar tools. Preferably, the list of actions is stored in and executed through a system action queue, but other options are also possible.

According to possible implementations, for at least some of the actions, pre-checks and/or post-checks are conducted before or after executing the actions. In the case where a pre-check or post-check for an action is unmet, additional information can be requested from the user via the CUI, retrieved through an API, and/or computed by the back-end system. Actions can include system actions and channel actions. “System actions” are actions which are executable by the back-end system, regardless of the website or web application. “Channel actions” are actions that can modify either one of the CUI and GUI, and are executable via a channel handler, by the front-end device. As such, “channel actions” can include CUI actions and/or GUI actions. User interactions with the website or web application can, therefore, trigger either CUI actions and/or GUI actions. In possible implementations, the CUI can be displayed as a semi-transparent overlay extending over the GUI of the website or web application. The visual representation of the CUI can also be modified, based on either CUI or GUI inputs.

According to possible implementations, user interactions between the user and the CUI can be carried out across multiple devices and platforms as continuous conversations. For example, short-lived, single use access tokens can be used to redirect users from a first device or platform to other devices or platforms, while maintaining the GUI interaction history and/or CUI interaction history and the context chain.

According to another aspect, a system for executing the method described above is provided. The system includes a back-end system in communication with the front-end device and comprises the Front-End Understanding (FEU) module and the Natural Language Processing (NLP) module. The system also includes a context module for building the context chain, and a Behavior Determination module, for finding the match between user intent and the context chain and for retrieving a list of actions based on said match. The system also includes an action execution module for executing the system actions at the back-end system and sending executing instructions to the front-end device for channel actions, to modify the CUI, based on the captured GUI inputs; and/or modifying the GUI, based on the captured CUI inputs. Optionally, the system can include a database or a data store, which can be referred to as a database distributed across several database servers. The data store can store the list of actions; the captured GUI inputs and CUI inputs; and GUI interaction history and/or CUI interaction history of the user on the website or web application, as well as other parameters, lists and tables. According to different configurations, the system can include one or more of the following computing modules: Artificial Intelligence module(s); Cognitive Computing module(s); Sentiment Analysis module(s); Emotional Analysis module(s); and Customer Relationship Management (CRM) module(s). In some implementation, the system comprises a channel handler, to be able to send instructions formatted according to different channels (website, messaging platform, etc.). In some implementation, the system also includes the front-end devices, provided with display screens, tactile or not, and input capture accessories, such as keyboard, mouse, microphones, to capture the user input, and modify the graphical user interface of the website or web application accordingly.

According to another aspect, a non-transitory computer-readable storage medium storing executable computer program instructions is provided, for performing the steps described above.

### BRIEF DESCRIPTION OF THE DRAWINGS

FIG. 1A is a schematic diagram of components of the system for modifying the CUI and GUI associated with a website or a web application. The website or web application is executed through a web browser application on a front-end device and the back-end system processes user interactions, according to a possible embodiment.

FIG. 1B is a flow diagram providing a high-level overview of the method for modifying the CUI and GUI associated with a website or a web application, according to a possible embodiment. Also depicted is a graphical representation of a possible context chain at a point in time of a user interaction.

FIG. 1C is another flow diagram providing more details on a portion of the method, illustrating that user interactions with the GUI and CUI can trigger different types of actions, including system and channel actions.

FIG. 2 is a functional diagram schematically illustrating the system, including front-end device provided with input capture accessories and back-end hardware and software components, part of a back-end system, according to a possible embodiment.

FIG. 3 is a flow diagram of possible steps executed by the back-end system, based on current user intent and session context.

FIG. 4A is a representation of the intent-context to action mapping table, that can be stored in a data store or database of the back-end system. FIG. 4B is an example of an excerpt of a possible mapping table.

FIG. 5A is a representation of a database table mapping unique identifiers (UIDs) with their retrieval actions, according to a possible embodiment. FIG. 5B is an example of an excerpt of a possible mapping table of unique identifiers and associated retrieval actions.

FIG. 6A is a flow diagram illustrating the execution of system actions. FIG. 6B is an example of a flow diagram of a system action. FIG. 6C is a flow diagram illustrating the execution of channel actions. FIG. 6D is an example of a flow diagram of channel actions.

FIG. 7 is a flow diagram illustrating exemplary steps of the method for modifying the CUI and GUI associated with a website or a web application, according to a possible embodiment.

FIG. 8 is a table of examples of different actions that can be retrieved and executed as part of an action queue after a user makes a specific request, according to possible steps of the method.

FIG. 9 is a representation of the flow for the retrieval of messages when a message action is dispatched.

FIGS. 10A and 10B are diagrams that provide examples of how a user can seamlessly switch from one channel to another, as continuous conversations, using access tokens, according to a possible embodiment.

FIG. 11 is a diagram that provides another example of how a user can seamlessly switch from one platform/channel to another.

FIG. 12A is a diagram that illustrates different ways in which a CUI can be embedded into an existing, “traditional”, website. FIG. 12B is a diagram that illustrates the process by which the system is able to track, log, and respond to traditional UI events, such as clicks, hovers, and taps.

FIG. 13 is an illustration of an example hybrid interface-enabled e-commerce website showing the messaging window and the visual interface, according to a possible embodiment.

FIG. 14 is an illustration of an example hybrid interface-enabled e-commerce website showing the system response/action to the user input, “Show me T-shirts with happy faces on them”, according to a possible embodiment.

FIG. 15 is an illustration of an example hybrid interface-enabled e-commerce website showing the system response/action to the user action of mouse clicking on a particular T-shirt, according to a possible embodiment.

FIG. 16 is a flow diagram illustrating the option using a spoken hotword to activate the CUI, according to a possible embodiment.

### DETAILED DESCRIPTION

While speculation exists that CUIs will eventually replace websites and mobile applications (apps), the ability to leverage the respective advantages of GUIs and CUIs through a hybrid approach bears the greatest promise of not only improving user experience, but also providing an entirely new means of user engagement. A CUI that is fully integrated into a website or web application can allow the user to have a frictionless, intuitive means of interaction compared with traditional means, such as repetitive mouse point-and-click or touch screen tapping. It will be noted that the terms “website” and “web application” will be used interchangeably throughout the specification. As well known in the field, a “website” refers to a group of pages created which are executable through a web browser application, and where the pages include hyperlinks to one another. Also well known in the field, “web applications”, also referred to as “web apps”, are typically client-server applications, which are accessed over a network connection, for example using HyperText Transfer Protocol (HTTP). Web applications can include messaging applications, word processors, spreadsheet applications, etc.

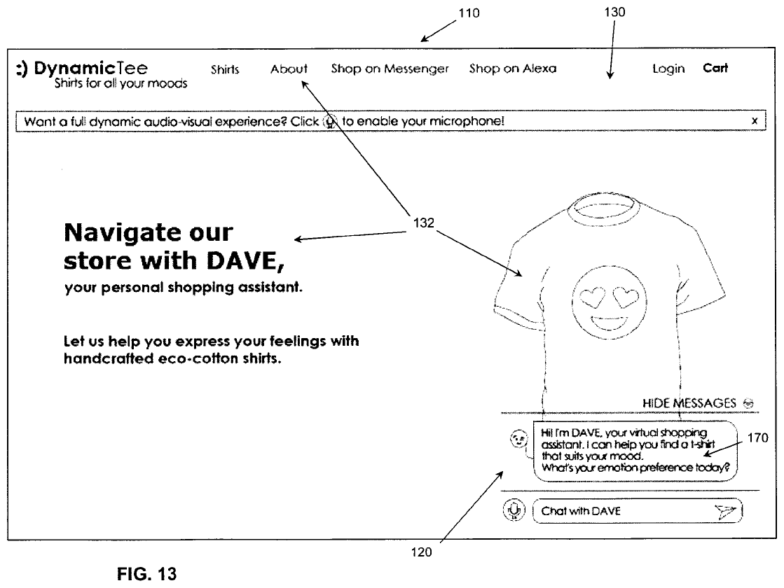

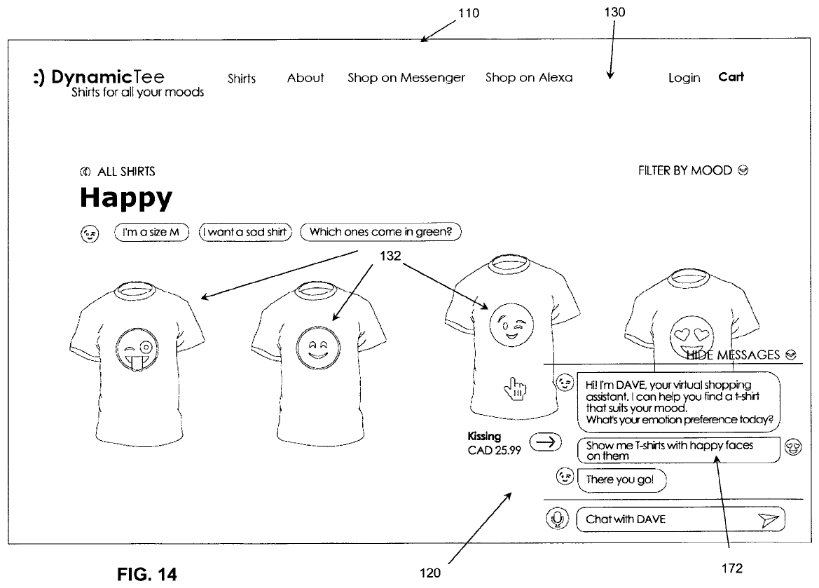

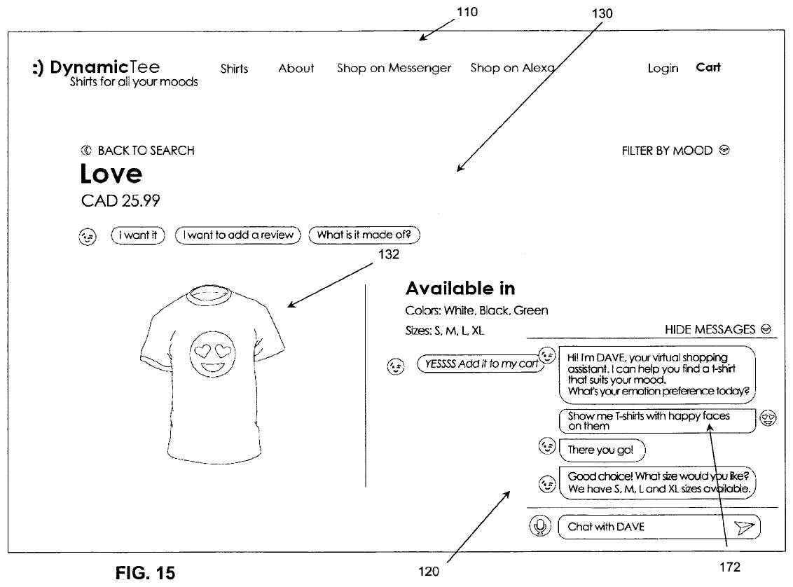

For the sake of clarity, Graphical User Interface (GUI) is here defined as a type of interface associated to, without being limitative: web sites, web applications, mobile applications, and personal computer applications, that displays information on a display screen of the processor-based devices, and allows user to interact with the device through visual elements or icons, with which a user can interact by the traditional means of communication (text entry, click, hover, tap, etc.). User interactions with visual features of the graphical user interface triggers a change of state of the web site or web application (such as redirecting the user to another web page or showing a new image product or trigger an action to be executed, such as playing a video). By comparison, a Conversational User Interface (CUI) is an interface with which a user or a group of users can interact using languages generally utilized for communications between human beings, which can be input into the CUI by typing text in a human language, by speech audio input, or by other means of electronic capture of the means of communication which humans use to communicate with one another. A CUI may be a self-contained software application capable of carrying tasks out on its own, or it may be mounted onto/embedded into another application's GUI to assist a user or a group of users in their use of the host GUI-based application. Such a CUI may be running in the background of the host application, in a manner that is not visible on the GUI, or it may have visual elements, (e.g. a text input bar, a display of sent and/or received messages, suggestions of replies, etc.) that are visually embedded in or overlaid on the host application's GUI. In FIG. 13, FIG. 14 and FIG. 15, we see an example of an e-commerce website selling T-shirts, where the CUI is referred to under 120 and the host GUI under 130.

The proposed hybrid interface system and method allows a user to have a bidirectional interaction with a website or web application, in which both the GUI and CUI associated with the website or web application can be modified or altered, based on user interactions. The proposed hybrid interface allows a user to request the item they are seeking or the action they want to perform (e.g. purchase) by text or voice and is significantly more efficient than traditional means. A series of mouse clicks, panning, scrolling, tapping, etc. is simply reduced to a few (or even a single) phrase(s) (e.g. “Show me women's shirts”; “Buy the blue shirt in a medium size”). Ultimately, this seamless combination of conversational and visual interactions yields a more engaging user experience, and results in improved return-on-investment for the business.

The system and method described herein are designed to provide users with a user conversation interface that (1) can substitute for the traditional means of communication (text entry, click, hover, tap, etc.) with a software application (web, native mobile, etc.); (2) recognizes the traditional means of communication (text entry, click, hover, tap, etc.) with a software application (web, native mobile, etc.); and (3) retains the state of conversation with the same user or group of users across different channels, such as messaging platforms, virtual assistants, web applications, etc. The user can interact with the system via voice, text, and/or other means of communication. According to possible embodiments, the modular architecture of the system may include multiple artificial intelligence and cognitive computing modules, such as natural language processing/understanding modules; data science engines; and machine learning modules, as well channel handlers to manage communication between web clients, social media applications (apps), Internet-of-Things (IoT) devices, and the system server. The system can update a database or data store with every user interaction, and every interaction can be recorded and analyzed to provide a response and/or action back to the user. The system is intended to provide the user with a more natural, intuitive, and efficient means of interacting with software applications, thereby improving the user experience.

A channel can be defined as a generic software interface, as part of the system, that relays user inputs to an application server and conversation agent outputs to the user, by converting the format of data and the protocols used within the system to those used by the platform, interface and/or device though which the user is communicating with the conversational agent.

The intent of the user may be determined based on the captured CUI inputs and/or the captured GUI inputs. The context is also determined based on GUI interaction history and/or CUI history. The CUI or GUI of the website is then modified to reflect a match between the intent and the context determined. The captured inputs can include CUI interactions, such as text captured through keyboard, or audio speech captured through a microphone, or GUI interactions. GUI interactions include mouse clicks, tapping, hovering, scrolling, typing, dragging of/on visual elements of GUI of the website or web applications, such as text, icons, hyperlinks, images, videos, etc. Optionally, the CUI comprises a messaging window which is displayed over or within the GUI of the web application or website. By “context”, it is meant data information relating to a user, to the environment of the user, to recent interactions of the user with visual elements a website or web application, and/or to recent exchanges of the user with a CUI of a website or web application. The context information can be stored in a “context chain”, which is a data structure that contains a name as well as context information data. A context chain can include single context element or multiple context elements. A context chain can include data related to the page the user is currently browsing and/or visual representation of products having been clicked on by the user. Context data may also include data on the user, such as the sex, age, country of residence of the user, and can also include additional “environmental” or “external” data, such as the weather, the date, and time. Context relates to and, therefore, tracks the state or history of the conversation and/or the state or history of the interaction with the GUI. Contexts are chained together into one context chain, where each context has access to the data stored within the contexts that were added to the chain before it was added. Mappings are done between the name of the context and the name of the intent.

A computer system is also provided, for implementing the described method. The system comprises a back-end system including computing modules executable from a server, cluster of servers, or cloud-based server farms. The computing modules determine the intent of the user and the context of the user interactions, based on the captured inputs. The computing modules then modify the GUI and/or CUI, with the modification made reflecting a match between the intent and context previously determined. The back-end system interacts with one or several front-end devices, displaying the GUI, which is part of the website, and executing the CUI (which can be a visual or audio interface). The front-end device and/or associated accessories (keyboard, tactile screen, microphone, smart speaker) captures inputs from the users.

The system and methods disclosed provides a solution to the need for a hybrid system with bi-directional communication between a CUI and a website or web application with a conventional visual/graphical user interface. The system consists of client-side (front-end) and server-side (back-end) components. The client-side user interface may take the form of a messaging window that allows the user to provide text input or select an option for voice input, as well as a visual interface (e.g. website or web application). The server-side application is comprised of multiple, interchangeable, interconnected modules to process the user input and to return a response as text and/or synthetic speech, as well as perform specific actions on the website or web application visual interface.

With respect to the functionality of this hybrid system, the user input may include one or a combination of the following actions: (1) speech input in a messaging window, (2) text input to the messaging window, (3) interaction (click, text, scroll, tap) with the GUI of the website or web application. The action is transmitted to and received by the back-end system. In the case of (1), the speech can be converted to text by a speech-to-text conversion module (“Speech-to-Text Engine”). The converted text, in the case of (1), or directly inputted (i.e. typed) text; in the case of (2), can undergo various processing steps through a computing pipeline. For example, the text is sent to an NLU/NLP module that generates specific outputs, such as intent and query parameters. The text may also be sent to other modules (e.g. sentiment analysis; customer relationship management [CRM] system; other analytics engines). These outputs then generate, for given applicative contexts, a list of system actions to perform. Alternately, it is also possible to process audio speech signals without converting the signals into text. In this case, speech audio signal is converted directly into intent and/or context information.

The actions may include one or multiple text responses and/or follow-up queries that are transmitted to and received by the client-side web application or website, through the CUI, which can be visually presented as a messaging window. If the end-user has enabled text-to-speech functionalities, the text responses can be converted to audio output; this process results in a two-way conversational exchange between the user and the system. The actions may also alter the client-side GUI (e.g. shows a particular image on the visual interface) or trigger native functionalities on it (e.g. makes an HTTP request over the network). As such, a single user input to a messaging window of the CUI may prompt a conversational, a visual, or a functional response, or any combination of these actions. As an illustrative example, suppose the user speaks the phrase “Show me T-shirts with happy faces on them” on an e-commerce website enabled with the hybrid CUI/GUI system. The following actions could result: the system would generate a reply of “Here are our available T-shirts with happy faces” in the messaging window; at the same time, a range of shirts would appear in the visual interface; the system would then prompt the user, again through the messaging window, with a follow-up question: “Is there one that you like?” The uniqueness of this aspect of the system is that a text or speech input is able to modify the website or web application in lieu of the traditional inputs (e.g. click, tap).

As an alternate scenario, the user may interact directly with the GUI of the website or web application through a conventional means, as per case (3) above. In this case, the click/tap/hover/etc. action is transmitted to and received by the server-side application of the back-end system. In addition to the expected functionalities triggered on the GUI, the system will also provide the specific nature of the action to a computational engine, which, just as for messaging inputs above, will output a list of system actions to be performed, often (but not necessarily) including a message response from a conversational agent to be transmitted to and received by the client-side application within the messaging window. As such, a single user input to the GUI may prompt both a visual and conversational response. As an illustrative example, suppose the user mouse clicks on a particular T-shirt, shown on the aforementioned e-commerce website enabled with the hybrid CUI/GUI system. The following actions could result: details of that shirt (e.g. available sizes, available stock, delivery time) are shown in the visual interface; the text, “Good choice! What size would you like?”, also appears in the messaging window. The uniqueness of this aspect of the system is that traditional inputs (e.g. click, tap) are able to prompt text and/or speech output.

The described system and method provide the user with a range of options to interact with a website or web application (e.g. speech/voice messaging, text messaging, click, tap, etc.). This enhanced freedom can facilitate the most intuitive means of interaction to provide an improved user experience. For example, in some cases, speech input may be more natural or simpler than a series of mouse clicks (e.g. “Show me women's T-shirts with happy faces available in a small size”). In other cases, a single mouse click (to select a particular T-shirt) may be faster than a lengthy description of the desired action via voice interface (e.g. “I would like the T-shirt in the second row, third from left”). The complementary nature of the conversational and visual user interfaces will ultimately provide the optimal user experience and is anticipated to result in greater user engagement. The user (customer) may, therefore, visit a hybrid interface-enabled e-commerce site more frequently or purchase more goods from that site compared to a traditional e-commerce site, thereby increasing the return-on-investment (ROI) to the e-commerce business.

In the following description, similar features in different embodiments have been given similar reference numbers. For the sake of simplicity and clarity, namely so as to not unduly burden the figures with unneeded references numbers, not all figures contain references to all the components and features; references to some components and features may be found in only one figure, and components and features of the present disclosure which are illustrated in other figures can be easily inferred therefrom.

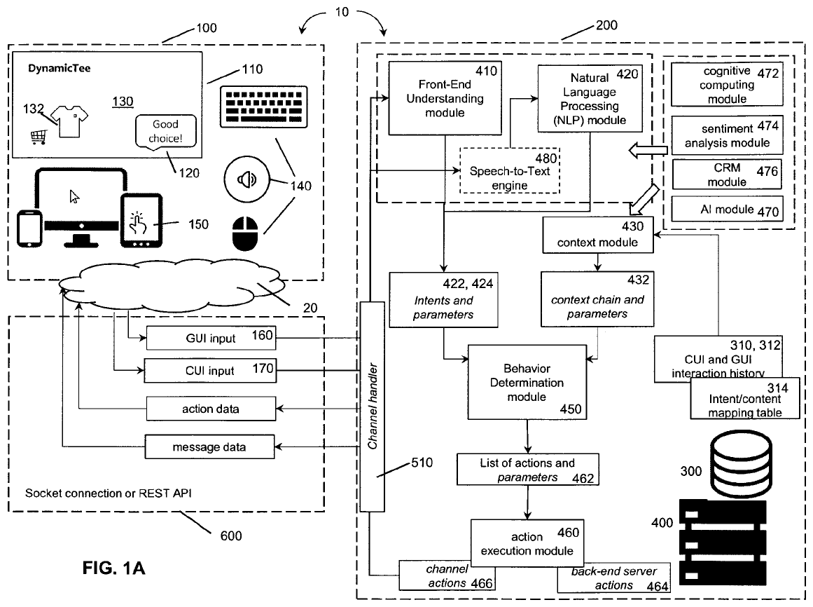

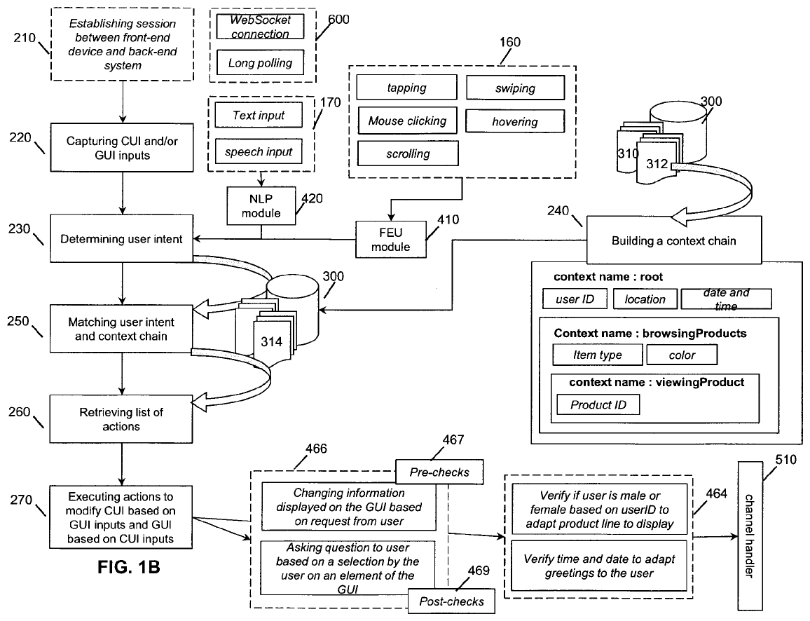

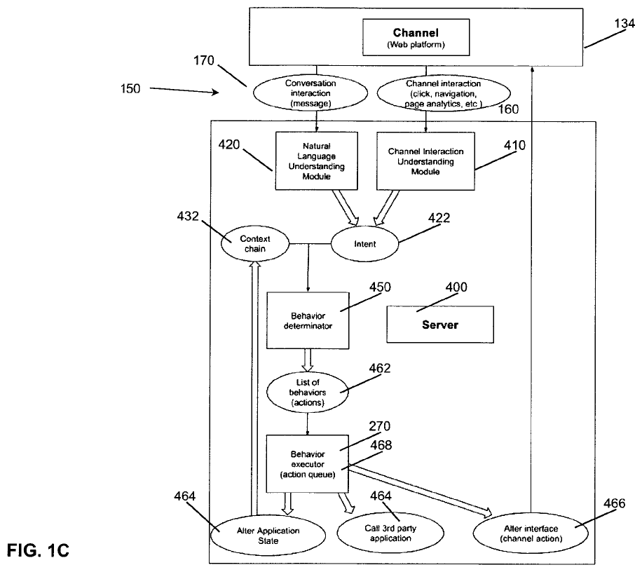

FIG. 1A is a schematic drawing showing the main components of the system 10, according to a possible embodiment of the invention. It comprises a Conversational User Interface (CUI) 120, a Graphical User Interface (GUI) 130 associated with a website or web application 110, which is executable on one or more front-end devices 100 of the system 10. User interactions are captured with input capture accessories 140 associated with the front-end devices, such as keyboards 142, microphone, tactile display screens, mouse, etc. The system 10 also comprises a back-end system 200 or server-side, including a channel handler 510, a plurality of computing modules 410, 420, 450, 460 and one or more data stores 300. The back-end system may also include or access additional computing modules, such as a cognitive computing module 472, a sentiment analysis module 474, a Customer Relationship Management (CRM) module 476, and an Artificial Intelligence (Al) module 470. It will be noted that the servers 400 and/or databases 300 of the back-end system 200 can be implemented as on a single server, on a cluster of servers, or distributed on cloud-based server farms. The one or more front-end devices can communicate with the back-end system 200 over a communication network 20, which can comprise an internal network, such as a LAN or WAN, or a larger publicly available network, such as the World Wide Web, via the HTTP or WebSocket protocol. User interactions 150, which can include GUI inputs 160 or CUI inputs 170, are captured in either one of the CUI and GUI and are sent to the back-end system 200 to be analyzed and processed. The back-end system 200 comprises computing modules, including a Front-End Understanding module 410, through which GUI inputs are passed, or processed, for analysis and intent determination, and a Natural Language Processing (NLP) module 420, through which the CUI inputs are passed or processed, also to determine user intent, and associated query parameters. Based on said analysis, the modules 410, 420 can determine user intents 422. Other modules, including a context module 430, are used to build a context chain 432, based on GUI interaction history and/or CUI interaction history of the user on the website or a web application 110. A user intent is data, which can be part of a list, table or other data structure, having been identified or selected from a larger list of predefined intent data structures, based on the captured inputs 160, 170. The context chain also be built or updated with the use of a CRM module 476 or of an Artificial Intelligence (Al) module. A Behavior Determination module 450 is used to find a match between the determined intent 422 of the user and the context chain 432 built based at least in part on the user's past exchanges in the GUI and/or CUI, referred to as CUI interaction history 312, and GUI interaction history 310. Based on the match of the user intent and the context chain, a list of actions 462, and corresponding parameters 424, is retrieved and sent to the action execution module 462. The actions are executed and/or managed by computing module 460 of the back-end system 200, and passed through a channel handler 510, to the corresponding channel 134 (identified on FIG. 1C) on which the website or web application is running, for altering or changing state of website or web application, either via its GUI or CUI.

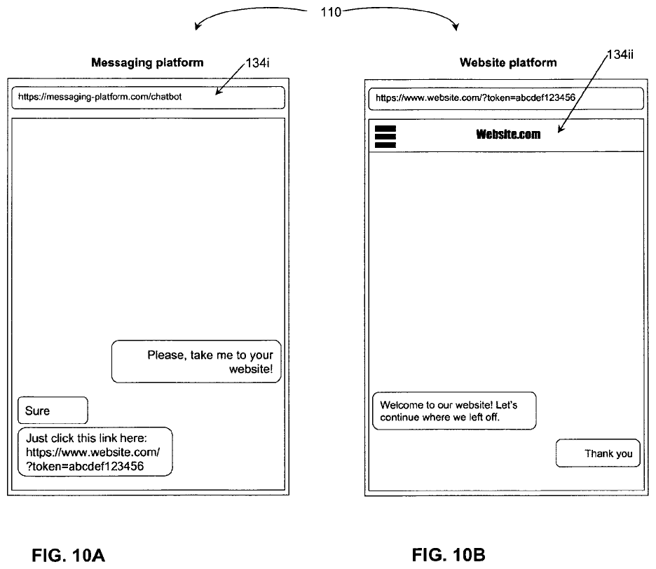

For example, if the user is communicating with a conversational agent through a CUI embedded on a web GUI, executable through a web browser, as is the case in FIGS. 1A-1C, the channel will maintain a connection over a protocol supported by web browsers (e.g. WebSocket, HTTP long-polling, etc.) between itself and the browser, receive inputs in the format that the CUI sends it in (e.g. JavaScript Object Notation (JSON)), reformat that data in the generic format expected by the system, and feed this re-formatted data to the system; conversely, when the system sends data to the user, the channel will receive this data in the generic system format, format it in a way that is expected by the CUI, and send this re-formatted data to the user's browser through the connection it maintains. In another example, if the user is communicating with the conversational agent through a messaging platform, as is the case in FIG. 10A, the channel will communicate with the messaging platform provider's servers in the protocol and with the data structure specified by the provider's Application Programming Interface (API) or Software Developer Kit (SDK), and with the system using the generic format used by it.

FIG. 1A, as well as FIGS. 1B and 1C, thus provide a high-level overview of different software and hardware components involved in the working of hybrid conversational and graphical user interface system 10, including the conversational user interface 120, or CUI (chat window, speech interface, etc.), the graphical user interface 130, or GUI (web browser, app, etc.), and the back-end system 200. FIG. 1B illustrates, in more detail, the main steps of the method, with the different back-end components involved, and provides examples of different types of user interactions 150, 170, and examples of system actions 464, which are executed in background and channel actions 466, which are noticeable by the user. FIG. 1C shows the different types of actions 464, 466, which can be executed by the front-end device and/or back-end server.

Referring to FIG. 1B, according to a possible implementation of the method, a communication between front-end device and the back-end system is first established. In FIG. 1B, the communication is established at step 210 with a session between the front-end device 100 and the back-end system 200; however, in other implementations, communication between the front-end device 100 and the back-end system 200 can be achieved by different means. For example, the CUI can make a call through an open WebSocket connection, a long-polling HTTP connection, or to a Representational State Transfer Application Programming Interface (REST API) with the back-end server through standard networking protocols.

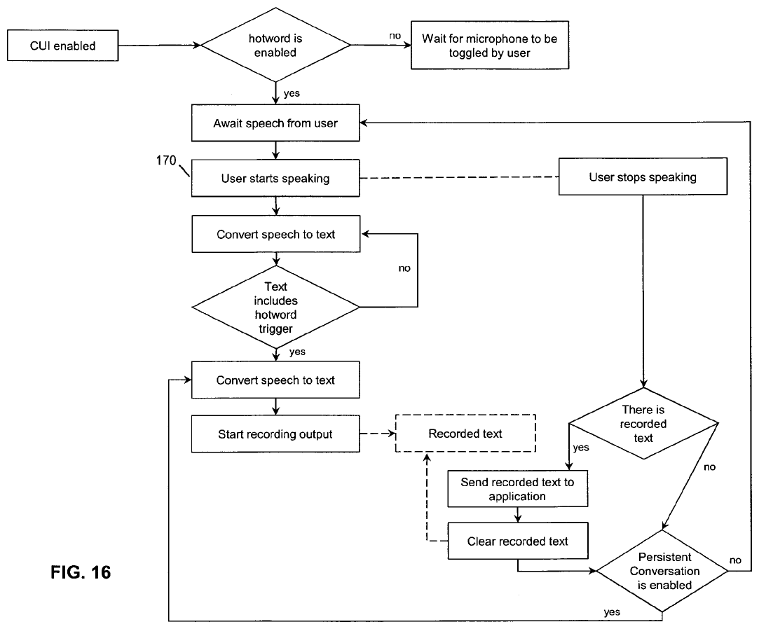

Still referring to FIG. 1B, when the user interacts with the website or web application 110 comprising both the CUI 120 and GUI 130, CUI inputs 170 or GUI inputs 160 are captured, as per step 220. The captured CUI inputs 170 can include text inputs and/or speech inputs. For example, written text can be captured in a messaging window, or speech spoken into a microphone, or another supported method of communication. In the case of speech, the audio is either converted to text using native browser support or sent to the server 400 that returns a string of text, which can then be displayed by the CUI 120. Speech audio signals can also be processed without a speech-to-text conversion engine. For example, the CUI can make a call through an open WebSocket connection and can transmit a binary representation of the recorded audio input 170 which is then processed by the back-end server 400. Speech audio signals can be collected by the CUI 120 in various ways, comprising: 1) after the user explicitly clicks a button on the CUI to activate a computing device's microphone; 2) during the entirety of the user's activity on a CUI, as described in FIG. 16, after the user utters a “hotword”, and that this hotword is locally recognized, whether the user needs to 2a) utter the “hotword” every time they wish to address the CUI, in which case the immediate sentence uttered after the “hotword” is deemed to be speech audio input, or 2b) in a manner that can be described as “persistent conversation”, where any sentence uttered by the user is deemed to be speech audio input.

Still referring to FIG. 1B, the user interacts with a messaging window, either by typing text or speaking into the device microphone. Once the user is finished with the message, the text is then sent to the server via a WebSocket or long polling connection 600. If the user provides spoken input, then the audio is streamed via connection 600 and parsed through a NLP module 420, and optionally to a speech-to-text engine, which converts the speech to text and, subsequently, displays the text in the messaging window as the user speaks. The text message is then processed on the server, to determine the user intent, as per step 230.

The context module builds and/or maintains the context chain, as per step 240. Building the context chain and determining user intent may require consulting and/or searching databases or data stores 300, which can store GUI and CUI interaction history 310, 312, and list or tables of predetermined user intents. Information on the user can also be stored therein. On the right-hand side of FIG. 1B is a graphical representation of a possible context chain at a point in time of a user interaction. As mentioned previously, a context is a data structure which is made of a name and of some data (accumulated and altered through the interactions between the user and the GUI and/or CUI). Contexts keep track of the state of the user interaction and are chained together. These contexts also contain parameters. All “children” contexts, which are added subsequently, can access the data parameters of their parent contexts. A context is added to the chain through actions. For example, as illustrated in FIG. 1B, in relation with step 240, before any interaction has happened, the application starts at the “root” context. The “root” context contains all the information regarding the user, the device, the conversation, the session 500, etc. These parameters vary depending on the application. The user then asks to view all blue shirts. As part of the action list, the action addContext is executed and the context named “browsingProducts” is added to the context chain with the parameter, color, and item Type as blue and shirts. The user then asks to view a specific shirt. During that interaction, the context, named, viewingProduct, is added to the context chain, with the UID of the product as a parameter. Should the user now input, “Add it to my cart”, the system would match the addToCart intent with the latest context and recognize which item to add to the cart. Similarly, should the user now input, “I don't like it”, the system could be set to return to the search with parameters blue and shirts.

Once the user intent is determined, the user intent and the context chain are matched, such as by using a lookup or mapping table 314 as per step 250. According to the match found, a list of action is retrieved, as per step 260, and send for execution at step 270. Examples of system actions 464 and channel actions 466 are provided. A system action 464 can include verifying whether the user is a male or female, based on a userID stored in the data store 300, in order to adapt the product line to display on the GUI. Another example of a system action 464 can include verifying the front-end device location, date and time, in order to adapt the message displayed or emitted by the CUI. Channel actions 466 can include changing the information displayed in the GUI, based on a request made by the user through the CUI, or asking a question to the user, based on a visual element of the GUI clicked on by the user. The server returns action(s), which may include an action to send a message back to the user, via a channel handler 510, which adapts the execution of the action based on the channel of the web application, the channel being, for example, a website, a messaging application, and the like. For example, an action to send a message is executed as a channel action through the web browser channel, and the messaging window displays this message and may also provide it as synthetic speech generated from a text-to-speech engine, if the device speaker has been enabled by the user. The user may also click or tap on a visual interface element on which the system is listening. This event is sent to the server via the WebSocket or long polling connection, and the action list for this event is retrieved and executed, in the same way as it is when the user interacts with the browser through text or speech.

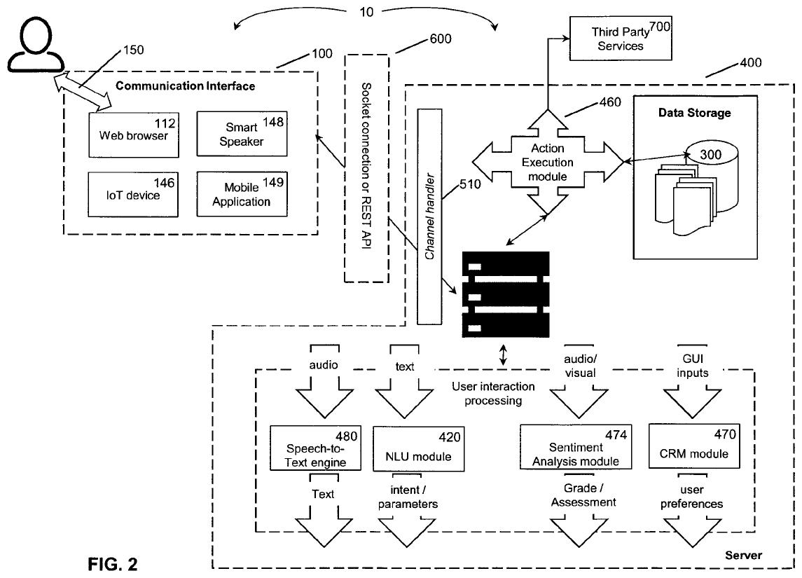

FIG. 2 illustrates the general system architecture 10, including front-end and back-end components 100, 400, as well as the flow of information. The diagram shows the components and modules of a particular instance of the system 10. Note that other modules, in addition to sentiment analysis modules 474 and customer analytics or Customer Relationship Managing (CRM) modules 470, can be included in the back-end processing pipeline and that other sources of input can be utilized for front-end user interaction.

In this example, the user accesses an instance of a hybrid interface-enabled platform, for example a web browser 112, a mobile application 149, a smart speaker 148, or an Internet-of-Things [IoT] device 146. If the user can be identified, then the system queries a database or data storage 300 to retrieve information, such as user behavior, preferences, and previous interactions. In this case, the user provides identification, or the browser has cookies enabled or user interface is identifiable. Information relevant to the user, as well as location, device details, etc., are set in the current context of the application. The user then interacts with the front-end user interface, e.g. speech, text, click, tap, on the front-end device 100. In the case of a web browser, this “interaction event” 150 is transmitted to the server (back-end) via WebSocket connection 600. In the case of a device/application using a REST application programming interface (API), such as Facebook Messenger bot, Amazon Echo device, Google Home device, etc., the user input triggers a call to a platform-dedicated REST API 600 endpoint on the server; and in the case of externally managed applications, such as Messenger or Google Home, application calls are rerouted to REST API endpoints on the server 400. If the request is determined by the system to contain speech audio, the system parses the audio through a Speech-to-Text engine 480 and generates a text string matching the query spoken by the user, as well as a confidence level. If the request contains conversation text as a string, or if audio was converted to a text string by a Speech-to-Text engine, then the string is passed through a NLU module 420 that queries an NLP service, which, in turn, returns an intent or a list of possible intents and query parameters are identified. The server 400 executes all other processing steps defined in a particular configuration. These processing steps include, without being limited to language translation, sentiment analysis and emotion recognition, using for example a sentiment analysis module 474. In this example, user query processing step include: language translations, through which the application logic makes a request to a third party translation service 700 and retrieves the query's English translation for processing; sentiment analysis, through which the application queries a third party sentiment analysis module 474 and retrieves a score evaluating the user's emotional state, so that text responses can be adapted accordingly. The server then queries the data store 300 to retrieve a list of actions to perform based on the identified intent and the current context. This process, referred to as intent-context-action mapping, is a key element of the functionality of the system. The retrieved actions are then executed by the action execution module 460 of the back-end server 400. These actions include, without being limited to, retrieving and sending the adequate response, querying the database, querying a third-party API, and updating the context chain; these actions are stored in the system data store 300. Actions that are to be executed at the front-end device are sent via the channel handler 510, to the appropriate channel. The CUI and/or CUI device/user interface executes any additional front-end device actions that could have been set to be triggered on each request. The browser, for example, can convert the received message via Text-to-Speech engine to “speak” a response to the user.

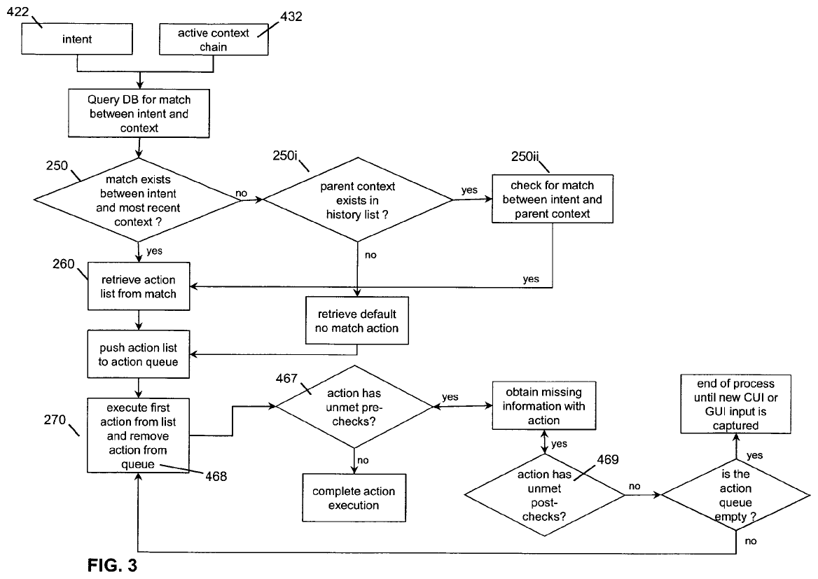

FIG. 3 is a flow diagram depicting the manner in which the system executes actions based on the current user intent 422 (determined by NLU/NLP) and the active context chain 432. The system receives the name of an intent from the NLP and queries the database for a match between the retrieved intent and the most recent application context.

If no match is found between the intent 422 and the most recent context 432 when the relevant database table is queried, then the system queries for a match with each subsequent parent context until a match is found and retrieves a list of actions resulting from that match, as per steps 250, 250i and 250ii. Alternatively, the system can feed the intent 422 and the structure of the context chain 432 to a probabilistic classification algorithm, which would output the most likely behavior, i.e. retrieve a list of actions, as per step 260, given the intent and context chain provided. The system can also feed the intent and context chain to a manually written, conditions-based algorithm, which would then determine the list of actions or “behavior” to be executed. Any combination of the aforementioned procedures can be used. The retrieved action list is then pushed to the action queue 468. The system checks if the first action in the action queue has pre-checks 467 and if they are all met. A pre-check is a property which must have a value stored in the current application context chain, in order for the action with the pre-check to run, and without which the series of actions is blocked from running. For example, if the action is adding an item to a shopping cart, then a pre-check would confirm that the system knows the ID of the selected item. If a pre-check property does not have a value in the current context chain, i.e. is not successful, then the system retrieves the required information through the execution of the actions defined in its own retrieval procedure. For example, the action that adds an item to a cart could require as a pre-check that the value of the quantity of items to add be existent in the current context, since knowing quantity is necessary to add an item to the cart. The pre-check retrieval action for quantity could be asking the user how much of the item they would like and storing that value in the current context. Until the value of the “quantity” property is set in the context, the CUI will ask the user how much they would like. Once all pre-check criteria have been met, the action is executed and removed from the action queue. Any unmet post-check requirements of this action are resolved through their retrieval procedure. The system checks for any remaining actions in the action queue, and if present, then executes the first action in the queue by repeating the process. Some actions are scripts that call a series of actions depending on different parameters. This approach allows the system to execute different actions depending on the identity of the user, for example. When this case is true, the actions called by another action are executed before the next action is retrieved from the action queue.

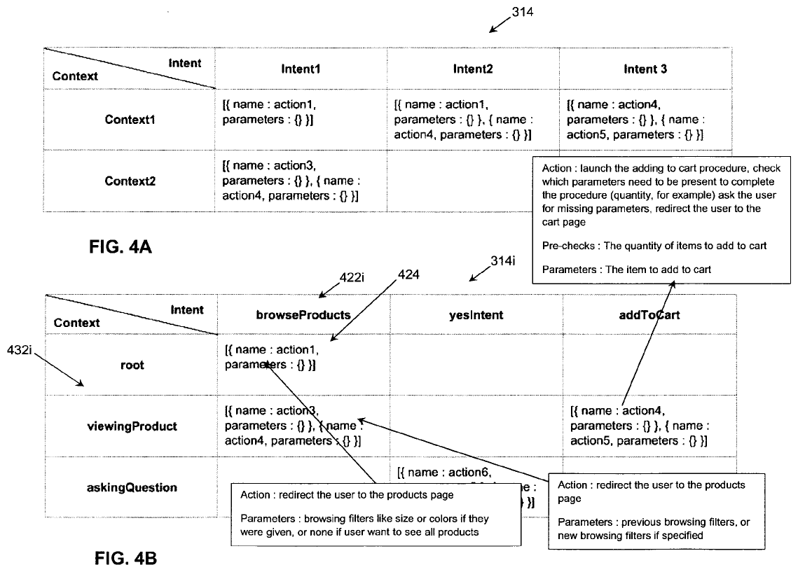

FIGS. 4A and 4B are representations of the intent-context to action mapping table 314 in the system database. FIG. 4A schematically illustrates a possible mapping table 314, and FIG. 4B provide a more specific example of a mapping table 314i according to exemplary intents and context, which when matched determine a list of actions to be executed. Context names are strings representing which stage the user is at in the conversation flow. Each intent is mapped with contexts in which it can be executed, as well as with a list of actions to perform in each of these contexts. If an intent cannot be realized in a given context, then a default error action list is triggered to signal to the user that their request cannot be executed. This example table shows how one intent, addToCart, can be executed in three different contexts:default, viewingProduct, and browsingProduct, with each context resulting in a different action list being returned. Similarly, different intents, in this example: addToCart and browseProducts, triggered in the same context (default) will return different action lists. Once retrieved, the action list is executed through the system action queue. Finding a match between user intent and context chain can be achieved with other means than with a mapping table. A probabilistic algorithm and/or conditional expressions embedded in the source code can also be considered for this step of the method.

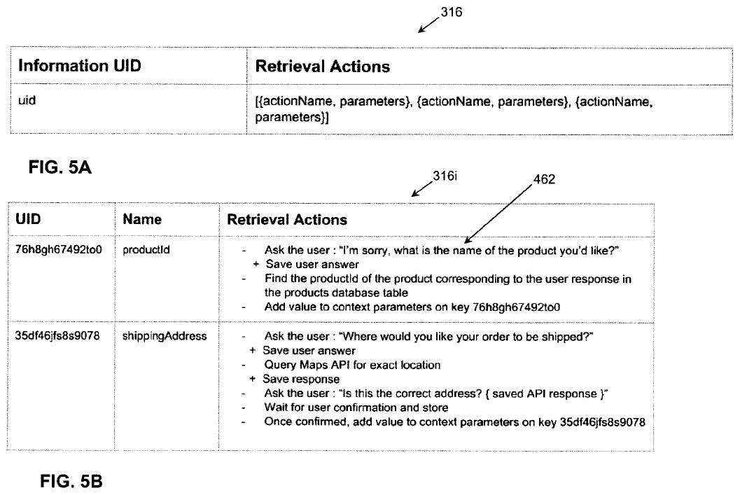

FIGS. 5A and 5B are exemplary representations of a database table 316 that can be used to map information unique identifiers (UIDs) with their retrieval actions. FIG. 5A provides a possible structure of the table, and FIG. 5B illustrates a subset of an exemplary table, with a list of actions 462 for a given UID. Actions have pre-checks and post-checks 469, which are information that is required to complete the action. When a pre-check or post-check 467, with a specific UID is missing and the action cannot be completed, the system looks up the retrieval procedure for the information with this specific UID. As shown in the “Example” table, the retrieval procedure for the information productId, which could be required if the user wanted to add an item to a cart, could be the following: (i) prompt the user to input the name of the product, which is saved in a variable; (ii) query the database for the ID of the product with the name that was provided; (iii) add the ID to the context. Once the retrieval procedure is complete, the system will continue with the action implementation. Another example could be the retrieval procedure for the information shippingAddress, where the system: (i) prompts the user for the shipping address and saves the answer; (ii) queries a third-party service provider's API for the saved address and saves the third-party formatted address; (iii) prompts the user to confirm the third-party formatted address; (iv) upon confirmation, stores the shipping address to the application context.

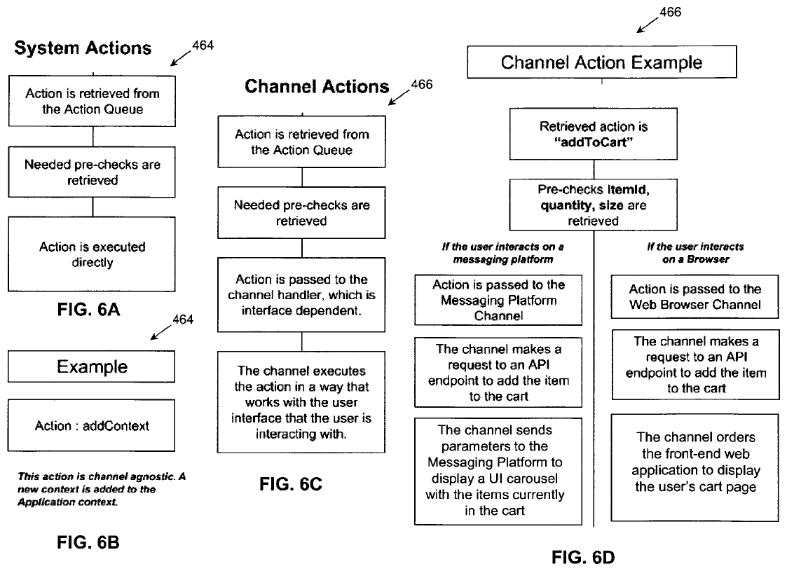

FIGS. 6A to 6D show flow diagrams that detail the execution of two types of actions, System actions 464 and Channel actions 466. Both action types can require pre-checks and post-checks. System actions are executed directly by the system. These actions are “channel agnostic”, meaning that their implementation is independent of the communication channel that is used to interact with the user (e.g. Web Browser Channel, Amazon Alexa Channel, Facebook Messenger Channel, IoT Device Channel). The actions 464 can include querying a third-party API to retrieve information, adding or deleting a context, querying the database, etc. Channel actions are dispatched to the channels for implementation. If an application or chatbot is available on multiple interfaces (e.g. Twitter, website, and e-mail), then the implementation of a channel action 466 will be sent to the channel of the interface with which the user is currently interacting, which will execute it in its particular way. For example, the channel action addToCartwill be executed differently by a Web Browser channel versus a Messaging Platform (e.g. Facebook Messenger, Kik) channel. While both channels will perform a request to the API to add the item to the cart, the Messaging Platform channel may, for example, return parameters to display a UI element, such as a carousel of the cart, while the Web Browser channel may return a request to redirect the user to the Cart webpage. It will also be noted that the channel actions 466 include both CUI actions and/or GUI actions, wherein each of the user interactions with the website or web application can trigger either CUI actions and/or GUI actions. More specifically, the system and method allow user interactions to trigger a CUI action, which modifies the state of the CUI, even if the captured input has been made in the GUI, and a GUI action can also be triggered, even if the captured input has been made through the CUI.

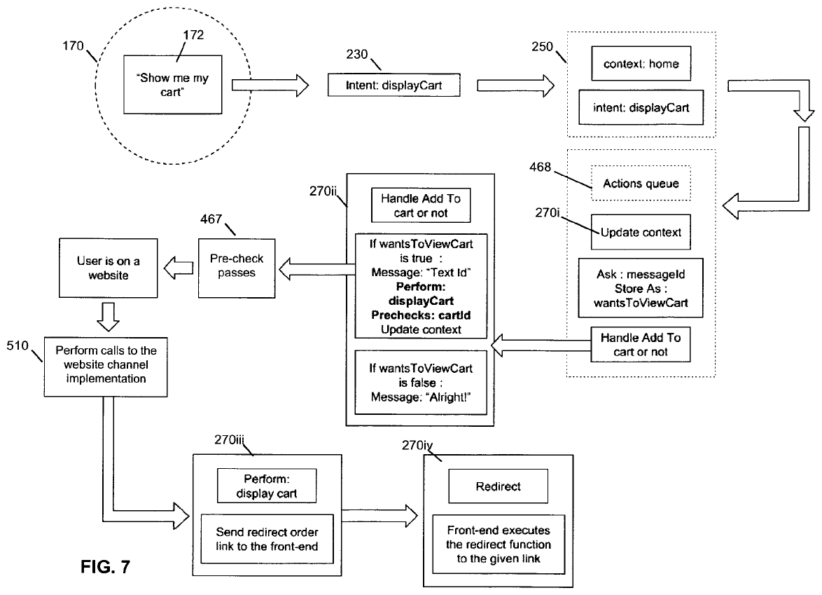

FIG. 7 describes the path to completion of one possible interaction, which starts when a user interaction, in this case a CUI input 170 corresponding to a spoken audio signal 172 is captured at the front-end device. The audio signal captured includes a user request: “Show me my cart”, on a Conversational User Interface located on a website. The intent is identified as a display cart, 230. The database is queried and returns an action queue 468 based on the match between the intent and the current context, 250. Actions in the action queue 468 are executed in order of the list of actions. The context is updated 270i and data is sent to the CUI to display a message (the message action), the text of which (“Here is your cart”) is retrieved. The next action, displayCart, is then performed, 270ii. Because the pre-check, or necessary information required to complete the action, is the ID of the cart, and since it is stored in the system, the pre-check passes 467. The system then retrieves the platform on which the user is interacting and calls the correct channel, 510. In this example, the user is browsing on a web page, so the perform action as described in the website channel is implemented, 270iii. This implementation consists of sending a redirect order to the front-end, so that the GUI is redirected to the cart page. This order is sent and then executed in the front-end, 270iv.

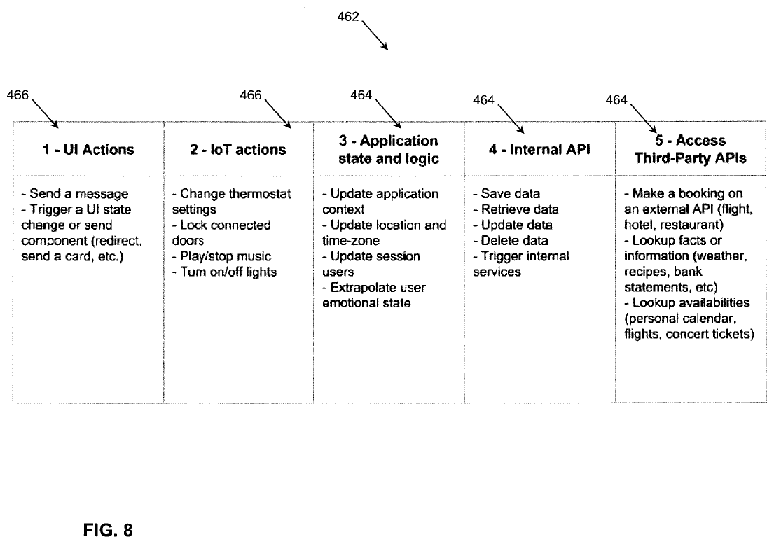

FIG. 8 provides a list or table 462 of examples of different actions that could be retrieved and executed as part of an action queue 468 after a user makes a specific request. Note that these actions can be both system and channel actions 464, 466, depending on whether or not they are channel agnostic. Channel actions 466 can affect the GUI 130 and display (e.g. send a message, redirect the browser to a certain page, etc.). If the user is interacting with an IoT device, then actions can make calls to the IoT device to change thermostat settings or turn on lights. Channel actions 466 are also used to modify the application state (e.g. adding or deleting a context, updating the location, etc.). Systems actions 464 can make calls to the application's own API, for example to add an item to a cart, to retrieve user profile information, etc. System actions 464 can also make calls to a third-party API to retrieve information, such as weather forecasts or concert tickets availabilities, or to make reservations, bookings, etc. System actions 464 are executed in a manner that does not involve the device or platform through which the user is using and that is not directly visible to the user (e.g. updating an entry in a database, querying a third-party service), whereas channel actions are relayed to the device or platform the user is using. Channel actions 466 can be classified in two sub-categories: CUI actions 463 and GUI actions 465. CUI actions involve altering the state of the Conversational User Interface (e.g. saying a message from the conversational agent), including the graphical representation of the CUI, if it exists (e.g. displaying suggestions of replies that the user can use as a follow-up in their conversation with the conversational agent). GUI actions involve altering the state of the software application within which the CUI is embedded (e.g. redirecting a web site to a new page, emulating a click on a button inside a web application). All of these types of actions can be executed as a result of user interactions with a website or web application, as part of the process described in earlier paragraphs.

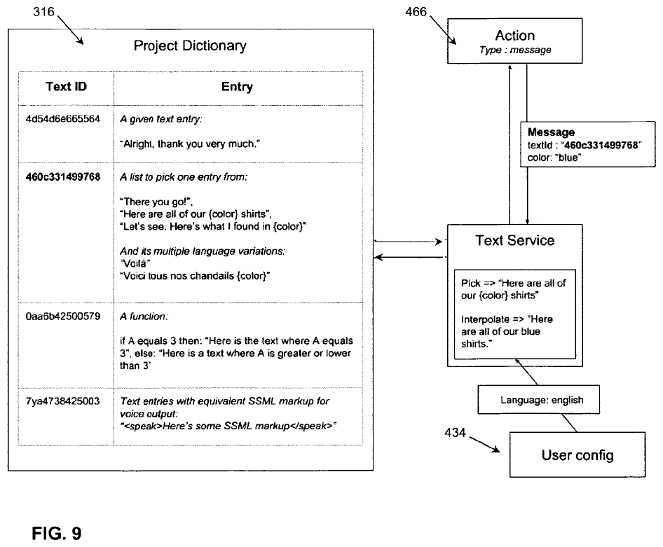

FIG. 9 is an exemplary representation of the flow for the retrieval of messages when a message action is dispatched. A message action 466 is dispatched from the action queue to the text service, with the textId, which represents the identification (ID) of the string to retrieve, and query parameters (here color is blue). The text service queries an application dictionary, which is a table of arrays, strings, and functions that return strings, and retrieves the entry that matches the UID received from the action 466 and the language setting in the user's configuration 434. An algorithm (e.g. a randomizer algorithm, a rotator algorithm, a best fit algorithm, etc.) is used to choose one string out of lists of strings, or to interpolate parameters within strings. In this example, the text service returns “Here are all of our blue shirts”, 3. The text string is then returned and passed to the appropriate communication channel used by the user, which then relays the message.

FIGS. 10A and 10B provide an example of a mechanism enabling the user of a hybrid CUI/GUI system to carry out continuous conversations across devices and platforms 110, while retaining the stored contexts and information. In this example, the user is using the CUI chatbot interface on a third-party messaging platform, which can be considered as a first channel 134i, and wants to carry the conversation over to a website interface, which can be considered as a second channel 134ii. The system produces a short-lived, single-use access token, and appends it to a hyperlink that is sent to the user as a message by the system. When the user selects that hyperlink, they are redirected to the website interface, where the server validates the token, maps it to the appropriate session, and continues to carry on the conversation with the user through the website platform 134ii.

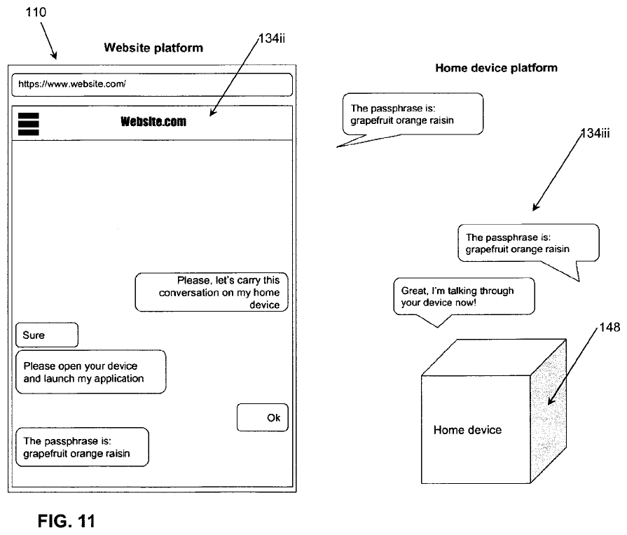

FIG. 11 provides another example of a mechanism enabling the user of a hybrid CUI/GUI system 10 to carry out continuous conversations across devices 110 and different websites and web applications, while retaining the stored contexts and information. In this example, the user is using the website interface 134ii and wishes to carry the conversation over to an audio-only home assistant device. The system then produces a short-lived, single-use passphrase; tells the user to turn on their home device and to launch the application 134iii associated to the system; if the user has enabled audio functionalities on the website interface 134ii, that interface will speak aloud the passphrase for the home assistant device to capture, or, will send the passphrase as a chat message, which the user can read aloud to the home assistant device. As above, that passphrase will then be mapped to the user's session, and the user can then continue the conversation through the home assistant device.

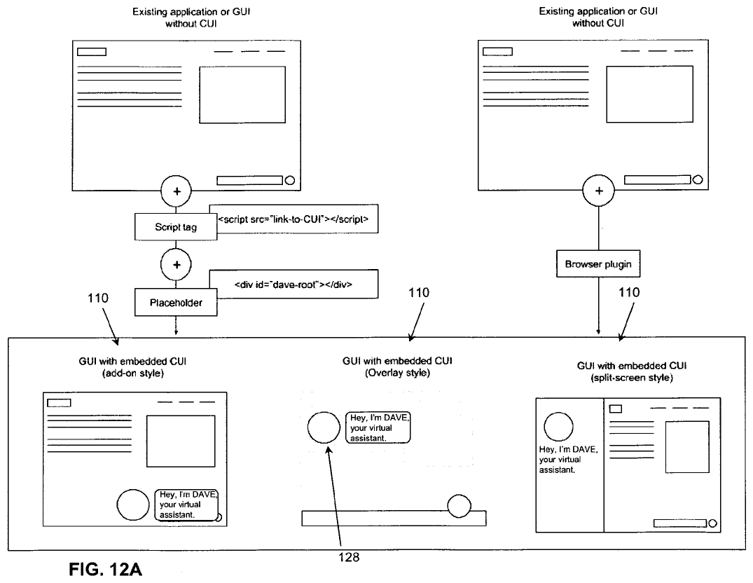

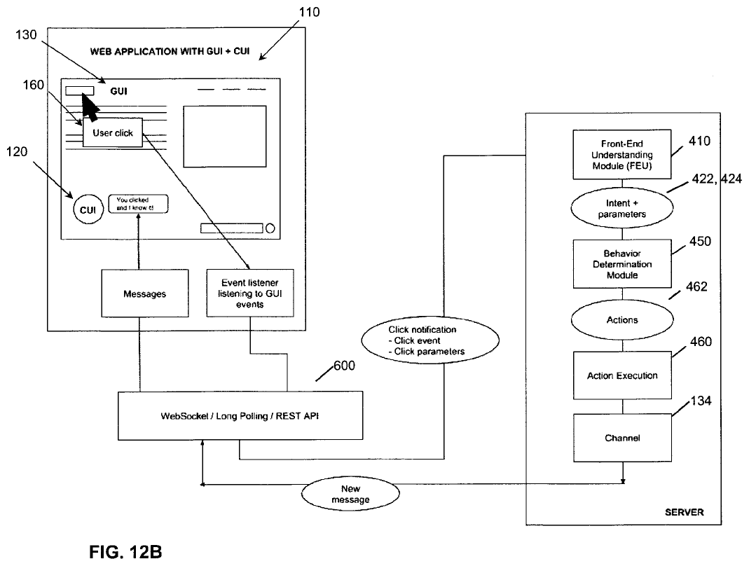

FIG. 12A is a graphical representation of different ways in which a CUI 120 can be embedded into an existing, “traditional”, website 110. The CUI 120 is first built independently of the existing website. It is set-up to handle communication with the server. The first way to embed a CUI 120 into a separate website 110 is to insert a snippet of JavaScript code into the HTML markup of the website, which instantiates a CUI 120 once the page is loaded or when the user activates the CUI 120. A placeholder tag is also added within which visual components instantiated by the CUI logic will render. Another option to embed a CUI 120 into an existing website 110 is to render the CUI code with a browser plugin when the URL matches a desired website 110. In both cases, the CUI 120 is, after embedding, able to both modify the existing website 110 by executing channel actions 466 sent from the server 400 and capturing GUI inputs 160 to send them to the server for processing. The CUI's graphical representation is agnostic to the conversation logic. The CUI 120 can be placed into the website in any location. For example, it could be displayed as a partially or semi-transparent overlay 128 on top of the existing GUI 130 of the website 110 or take up a portion of the screen next to it. These visual differences have no effect on application logic.

FIG. 12B demonstrates the procedure by which the system 10 can track, log, and respond to traditional GUI inputs 160 (or GUI events), such as clicks, hovers, and taps. A listener class is assigned to Document Object Model (DOM) elements that attach events, as well as data tags containing information about the action performed. A global listener function in the front-end code makes server calls. The Front-End Understanding Module (FEU) 410 converts each of these received interactions into user intents 422 before feeding them to the Behavior Determination module 450 to retrieve a list of actions 462 to execute. For example, should the user select a specific item to view during their shopping process by clicking on it (a GUI input), the CUI captures this click on the GUI and notifies the server of that interaction, including the parameters of the ID and name of the product to display. The FEU 410 receives that interaction and determines an intent and parameters 422, 424, which are then handled by the Behavior Determination module 450 which with the intent and current context retrieves a list of actions 462 to execute, in this case having the system respond with the phrase, “Great choice!”.

FIG. 13 is an illustration of an example hybrid-interaction enabled e-commerce website showing the messaging window and the visual interface. This illustrative example depicts a hybrid interface-enabled website 110 for a hypothetical, e-commerce company, “Dynamic Tees”, that sells T-shirts bearing emoji images. The website 110 includes a CUI 120, represented by a messaging window, and a GUI 130, which includes a plurality of visual elements 132, with which the user can interact. The user provides CUI input 170 by typing in the messaging window or by enabling the microphone using the icon button. The system 10 is able to provide text responses in the messaging window, and (optional) audio responses via the device (e.g. laptop, phone, tablet) speakers if the user has enabled the speaker option. In this example, the system provides the text, “Hi! I'm DAVE, your virtual shopping assistant. I can help you find a T-shirt that suits your mood. What's your emotion preference today?”, when the user lands on the website home page. The visual interface 130 appears like a traditional website with multimodal content and interaction elements (e.g. text, images, checkboxes, drop-down menus, buttons).

FIG. 14 is an illustration of an example hybrid-interaction enabled e-commerce website 110 showing the system response/action to the user input “Show me T-shirts with happy faces on them”. In this illustrative example, the user has either typed the phrase “Show me T-shirts with happy faces on them” or has spoken the phrase into the device microphone, following which the text will appear in the messaging window 120. Based on this input, the system then retrieved an intent through the NLU module 420, retrieved a list of actions 462 through the Behavior Determination module 450, executed those actions, which included a channel action 466 to redirect the user to a page, and finally updated the GUI 130 to show shirts with happy faces and additional associated information.

FIG. 15 is an illustration of an example hybrid-interaction enabled e-commerce website 110 showing the system response/action to the user action of clicking on a particular shirt. In this illustrative example, the user has used the mouse 144 to click on a particular shirt. The system 10 redirects to a page with more detail on this particular shirt, or in the case of a single-page application, updates the visual interface to show a component with that information, in the same manner as non-CUI driven websites do. In addition, the event listener on the CUI captures the click action and sends it to the server via WebSocket. The Front-End Understanding module retrieves an intent from that action, the Behavior Determination module retrieves a list of actions from the intent and the context, and one of these actions is to send a message. A channel action 466 is sent to the channel to the CUI 120 which displays the text, “Good choice! What size would you like? We have S, M, L, and XL sizes available.”, in the messaging window. This response may also play as audio via the device's speakers if the user has enabled the speaker option.

FIG. 16 provides an overview of the process for implementing the method being activated by a “hotword”, which is a specific word used to activate the CUI. If the “hotword mode” is enabled in a user's settings, the application continually awaits speech input 170 from the user. When the user starts speaking, the application converts speech into text using the browser's local speech-to-text functionality and checks if the spoken phrase includes the “hotword” defined in the application settings. If the text does not include the hotword, the application continues to convert speech to text and check for the presence of the “hotword”. If the text does include the “hotword”, the application records the outputted text until the user stops speaking. When the user stops speaking, if there is a value in the recorded text, the recorded text is sent to the server for processing and then cleared. If the persistent conversation feature is enabled in the user's settings, the application continues to listen to all user speech and to send recorded text to the server when there is a pause in the user's speech. If the “persistent conversation” feature is not enabled in the user's settings, the application returns to listen to speech input and check for the presence of the “hotword” in the user's speech.

As can be appreciated, the reported system is uniquely designed to provide users with a conversation interface that (1) can substitute for the traditional means of communication (text entry, click, hover, tap, etc.) with a software application (website or web application), (2) recognizes the traditional means of communication (text entry, click, hover, tap, etc.) with a software application (website or web application), and (3) retains the state of conversation with the same user or group of users across messaging platforms, virtual assistants, applications, channels, etc. The user is able to access the system via voice, text, and/or other means of communication. The modular architecture of the system includes multiple artificial intelligence, cognitive computing, and data science engines, such as natural language processing/understanding and machine learning, as well as communication channels between web client, social media applications (apps), Internet-of-Things (IoT) devices, and the system server. The system updates its database with every user interaction, and every interaction is recorded and analyzed to provide a response and/or action back to the user. The system is intended to provide the user with a more natural, intuitive, and efficient means of interacting with software applications, thereby improving the user experience.

While the above description provides examples of the embodiments, it will be appreciated that some features and/or functions of the described embodiments are susceptible to modification without departing from the principles of operation of the described embodiments. Accordingly, what has been described above has been intended to be illustrative and non-limiting and it will be understood by persons skilled in the art that other variants and modifications may be made without departing from the scope of the invention as defined in the claims appended hereto.

1. A computer-implemented method for modifying a Conversational User Interface (CUI) and Graphical User Interface (GUI) associated with a website or a web application running on a front-end device, the method comprising:
capturing user interactions with the website or web application on the front-end device, the user interactions including at least one of: GUI inputs and CUI inputs;
determining user intent, based on said at least one captured GUI and CUI inputs;
building a context chain, based on GUI interaction history and/or CUI interaction history of the user on the website or a web application;
finding a match between said intent and context chain;
retrieving a list of actions based on said match; and
executing said list of actions at the back-end system and/or at the front-end device and modifying the CUI, based on the captured GUI inputs; and/or modifying the GUI, based on the captured CUI inputs.

2. The computer-implemented method according to claim 1, comprising a step of establishing a session between the front-end device and a back-end system prior to capturing the user interactions.

3. The computer-implemented method according to claim 2, wherein the step of executing said list of actions includes changing information displayed on the GUI, based on a request made by the user through the CUI.

4. The computer-implemented method according to claim 3, wherein the step of executing said list of actions includes asking a question to the user, by displaying text or emitting speech audio signals, through the CUI, based on a selection by the user of a visual element displayed on the GUI.

5. The computer-implemented method according to claim 4, wherein:
the CUI inputs from the user include at least one of: text inputs; and speech inputs; and
the GUI inputs include at least one of: mouse clicking; scrolling; swiping; hovering; and tapping through the GUI.

6. The computer-implemented method according to claim 5, wherein the step of determining user intent comprises:
passing the CUI inputs through a Natural Language Understanding (NLU)/Natural Language Processing (NLP) module of the back-end system;
passing the GUI inputs through a Front-End Understanding (FEU) module of the back-end system module; and
selecting user intent from a list of predefined intents.

7. The computer-implemented method according to claim 6, comprising a step of associating query parameters with the selected user intent.

8. The computer-implemented method according to claim 5, wherein building the context chain comprises maintaining a plurality of contexts chained together, based on at least one of: navigation history on the GUI; conversation history of the user with the CUI; user identification, front-end device location, date and time.

9. The computer-implemented method according to claim 8, wherein the step of finding a match between said intent and context chain comprises using at least one of: a mapping table stored in a data store of a back-end system; a probabilistic algorithm; and conditional expressions embedded in the source code.

10. The computer-implemented method according to claim 9, wherein the step of retrieving the list of actions comprises using at least one of: a mapping table stored in a data store of a back-end system; a probabilistic algorithm; and
conditional expressions embedded in the source code.

11. The computer-implemented method according to claim 9, wherein parameters are extracted from either one of the determined intents and context chains, and are passed to the actions part of the list of actions, for execution thereof.

12. The computer-implemented method according to claim 11, wherein the list of actions is stored in and executed through a system action queue.

13. The computer-implemented method according to claim 8, wherein for at least some of said actions, pre-checks and/or post-checks are conducted before or after executing the actions.

14. The computer-implemented according to claim 13, wherein if a pre-check or post-check for an action is unmet, additional information is requested from the user via the CUI, retrieved through an API and/or computed by the back-end system.

15. The computer-implemented method according to claim 8, wherein actions include system actions and channel actions, the system actions being executable by the back-end system, regardless of the website or web application; and the channel actions being executable via a channel handler.

16. The computer-implemented method according to claim 15, wherein channel actions include CUI actions and/or GUI actions, and wherein each of the user interactions with the website or web application can trigger either CUI actions and/or GUI actions.

17. The computer-implemented method according to claim 8, wherein the step of determining user intent is performed using an Artificial Intelligence module and/or a Cognitive Computing module.

18. The computer-implemented method according to claim 8, wherein the step of determining user intent is performed using at least one of a Sentiment Analysis module, an Emotional Analysis module and/or a Customer Relationship Management (CRM) module.

19. The computer-implemented method according to claim 2, wherein the step of establishing a session between the front-end device and a back-end system is made via at least one of a Web Socket connection and an Application Program Interface (API) using the HyperText Transfer Protocol (HTTP).

20. The computer-implemented method according to claim 6, wherein when the captured inputs are speech audio signals, said audio signals are converted into text strings with the use of a Speech-to-Text engine.

21. The computer-implemented method according to claim 1, wherein the website is an e-commerce website.

22. The computer-implemented method according to claim 1, wherein the user interactions between the user and the CUI are carried out across multiple devices and platforms as continuous conversations.

23. The computer-implemented method according to claim 22, wherein short-lived, single use access tokens are used to redirect users from a first device or platform to other devices or platforms, while maintaining the GUI interaction history and/or CUI interaction history and the context chain.

24. The computer-implemented method according to claim 1, wherein the CUI is one of a native part of the website or web application or a browser plugin.

25. The computer-implemented method according to claim 24, wherein the CUI is displayed as a semi-transparent overlay extending over the GUI of the website or web application.

26. The computer-implemented method according to claim 25, comprising a step of activating the CUI using a hotword.

27. The computer-implemented method according to claim 5, comprising a step of modifying a visual representation of the CUI based on the GUI inputs.

28. A system for modifying a Conversational User Interface (CUI) and Graphical User Interface (GUI) associated with a website or a web application running on a front-end device, the system comprising:
a back-end system in communication with the front-end device, the back-end system comprising:
a Front-End Understanding (FEU) module and a Natural Language Understanding (NLU)/Natural Language Processing (NLP) module, for capturing user interactions with the website or web application, the user interactions including at least one of: GUI inputs and CUI inputs, and for determining a user intent, based on captured GUI inputs and/or CUI inputs;
a context module for building a context chain, based on GUI interaction history and/or CUI interaction history;
a behavior determination module for finding a match between said intent and said context chain and for retrieving a list of actions based on said match; and
an action execution module for executing system actions from said list of actions at the back-end system and sending executing instructions to the front-end device for channel actions of said list of actions, to modify the CUI, based on the captured GUI inputs; and/or modifying the GUI, based on the captured CUI inputs.

29. The system according to claim 28, comprising a data store for storing at least one of:
said list of actions;
the captured GUI inputs and CUI inputs; and
GUI interaction history and/or CUI interaction history of the user on the website or web application.

30. The system according to claim 29, wherein the executing instructions sent to the front-end device include channel action instructions to change information displayed on the GUI, based on a user request made by the user through the CUI.

31. The system according to claim 30, wherein the executing instructions sent to the front-end device include channel action instructions to ask a question to the user, by displaying text or emitting speech audio signals, through the CUI, based on a selection by the user of a visual element displayed on the GUI.

32. The system according to claim 31, wherein:
CUI inputs from the user include at least one of: text inputs and speech inputs; and
the GUI inputs include at least one of: mouse clicking; scrolling; swiping; hovering; and tapping through the GUI.

33. The system according to claim 32, wherein the context module builds the context chain by maintaining a plurality of contexts chained together, based on at least one of: navigation history on the GUI; conversation history of the user with the CUI; user identification, user location, date and time.

34. The system according to claim 28, wherein the data store comprises a mapping table used by the behavior determination module to find the match between said intent and context chain using stored in the database of a back-end system.

35. The system according to claim 33, wherein the behavior determination module extracts parameters from either one of the determined intent and context chain, and passes the parameters to the behavior determination module to execute the actions using the parameters.

36. The system according to claim 35, wherein the behavior determination module stores the list of actions in a system action queue.

37. The system according to claim 36, wherein for at least some of said actions, pre-checks and/or post-checks are conducted before or after executing the actions.

38. The system according to claim 28, wherein the back-end system comprises at least one of an Artificial Intelligence module and a Cognitive Computing modules, to determine the intent and the context chain associated with the captured GUI and the CUI inputs.

39. The system according to claim 38, wherein the back-end system further comprises at least one of a Sentiment Analysis module, an Emotional Analysis module, and a Customer Relationship Management (CRM) module, to determine the intent and the context chain associated with the captured GUI and the CUI inputs.

40. The system according to claim 39, wherein the back-end system comprises a Speech-to-Text engine, such that when the captured inputs are speech audio signals, said audio signals are converted into text strings with the use of the Speech-to-Text engine.

41. A non-transitory computer-readable storage medium storing executable computer program instructions for modifying a Conversational User Interface (CUI) and Graphical User Interface (GUI) associated with a website or a web application running on a front-end device, the instructions performing the steps of:
capturing user interactions with the web site or web application on the front-end device, the user interactions including at least one of: GUI inputs and CUI inputs;
determining user intent, based on said at least one captured GUI and CUI inputs;
building a context chain, based on GUI interaction history and/or CUI interaction history of the user on the website or a web application;
finding a match between said intent and context chain;
retrieving a list of actions based on said match; and
executing said list of actions at the back-end system and/or at the front-end device and modifying the CUI, based on the captured GUI inputs; and/or modifying the GUI, based on the captured CUI inputs.
